(19) United States
(12) Patent Application Publication
(10) Pub. No.: US 2006/0020967 A1
(43) Pub. Date: Jan. 26, 2006

(54) Dynamic selection and interposition of multimedia files in real-time communications

(75) Inventors: Brent L. Davis, Deerfield Beach, FL (US); Peeyush Jaiswal, Boca Raton, FL (US); James R. Lewis, Delray Beach, FL (US); Ion Loghin, Boynton Beach, FL (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, ARMONK, NY (US)

(21) Appl. No.: 10/898,807

(22) Filed: Jul. 26, 2004

(51) Int. Cl. H04N 5/445; G06F 13/00; G06F 3/00

(52) U.S. Cl. 725/37; 725/39; 725/47

(57) ABSTRACT

An apparatus and related methods for interfacing with a communication network and interactively interposing a multimedia file output during an electronic communication between a plurality of communication network communicators are provided. The apparatus includes a menu generation module that generates a menu listing at least one available multimedia file that can be selected for interposition into the communication by a network communicator, and a multimedia file module that outputs a multimedia file during the electronic communication in response to a menu selection by the communicator. The method includes providing a menu listing at least one available multimedia file that can be selected for interposition into the communication by a communicator, and interposing a selected multimedia file during the electronic communication.

### BACKGROUND

1. Field of the Invention

The present invention relates to electronic communications, and, more particularly, to interactive electronic communications utilizing multimedia presentations.

2. Background of the Invention

The smiley :-) is a convenient device for conveying emotions through the use of plain text. The typographically generated icon, according to most accounts, have been around since the early 1980s when the now familiar version of the smiley was first introduced. Since then the smiley has spawned an ever increasing number of variations of the original version. The proliferation of smiley variants has lead to different classifications. Among the different classifications there are basic smileys, widely used smileys, usenet smileys, midget smileys, mega smileys, emotional smileys, and a host of others. So significant has been the growth in the number of smiley variants and their usage, that today they are considered to be an integral part of the worldwide online social culture. The smiley and its many variants can even boast of having their own website http//:wwwcaipirinha.com/Smiley/smiley.html.

Despite the many uses to which the smiley has been applied, there appears not to have been an attempt to extend its use to telephony-based communications. Thus, the smiley which has been so widely applied over the Internet, does not appear to have been incorporated into systems that would allow two or more communicators to produce auditory or video smileys during a telephony-based communication.

### SUMMARY OF THE INVENTION

The present invention is directed to an apparatus and related methods for interfacing with a communication network and interactively interposing a multimedia file output during an electronic communication between two or more parties engaged in a voice conversation or dialogue over the communication network.

The apparatus can include a menu generation module. The menu generation module presents a list of available multimedia files. From the menu, a multimedia file can be selected for interposition into the communication by one of the parties to the conversation. The apparatus can further include a multimedia file module that outputs a selected multimedia file during the electronic communication between the parties.

The method can include providing a menu listing at least one available multimedia file. The multimedia files listed can be selected for interposition into the communication by a party to a multi-party communication over a communications network. The method additionally can include interposing the selected multimedia file during the electronic communication among the parties.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a communications network with which a system for interposing a multimedia file in an electronic communication according to one embodiment of the invention can be employed.

FIG. 2 is a schematic diagram of a system for interposing a multimedia file in an electronic communication according to one embodiment of the invention.

FIG. 3 is a flowchart illustrating one embodiment of a method for interposing a multimedia file in an electronic communication according to the present invention.

### DETAILED DESCRIPTION OF THE PREFERRED EMBODIMENTS

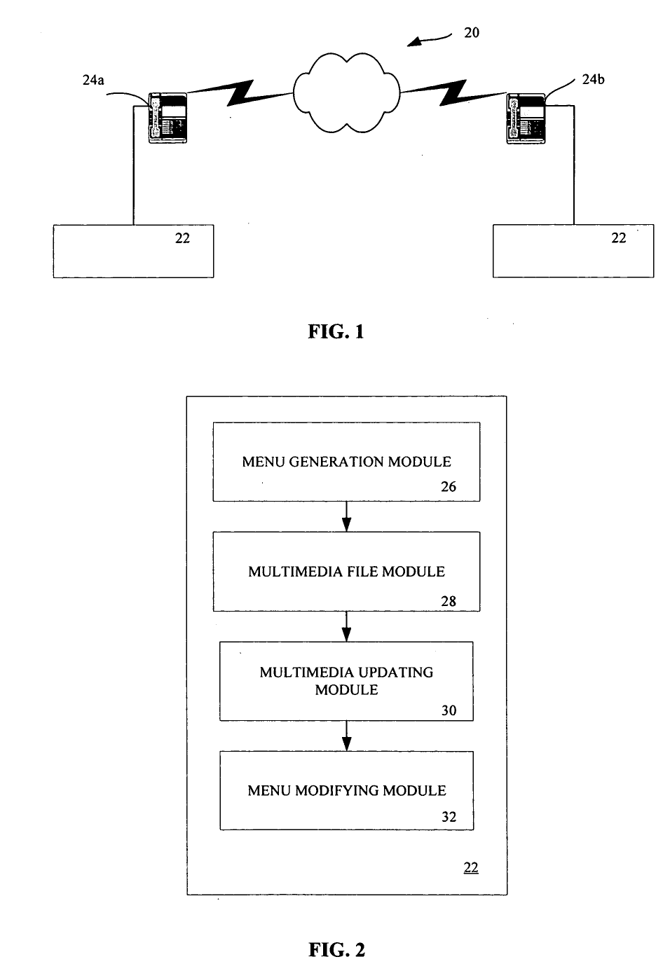

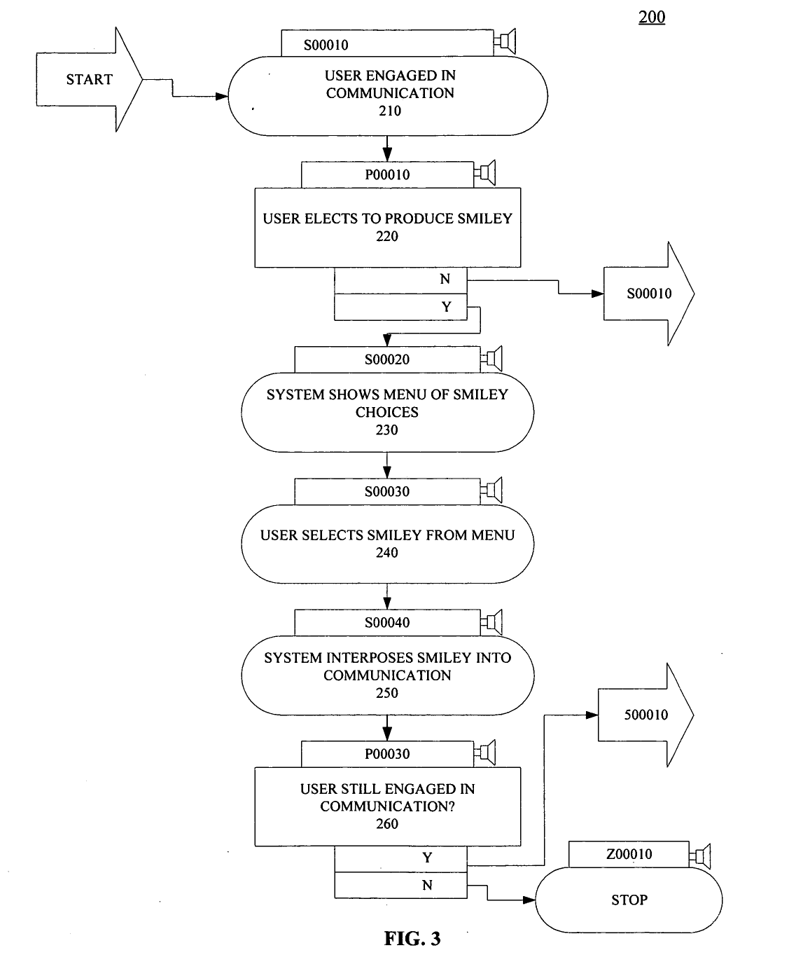

FIG. 1 provides a schematic diagram of a communications network 20 in which an apparatus 22 according to one embodiment of the invention can be advantageously employed. The network 20 illustratively includes two duplex voice-data communication devices 24a, 24b that communicate with each other. As will be readily apparent in the context of the ensuing discussion, the network 20 can alternately include other types of communication device in addition to, or in lieu of, the duplex voice-data communication devices 24a, 24b. Such other communication devices can include, for example, stand-alone general computers or application-specific devices having voice transmission and receiving capabilities.

Each apparatus 22 according to one embodiment of the invention is separately connected to one of the two duplex voice-data communication devices 24a, 24b. Each apparatus 22 interfaces with the communication network 20 via the duplex voice-data communication devices 24a, 24b. Each apparatus 22, moreover, interactively interposes a multimedia file output during an electronic communication between two or more communicators communicating with one another over the communication network 20 via duplex voice-data communication devices 24a, 24b. As used herein, the term multimedia file includes any stored data and associated processing instructions for presenting via a communication device multiple types of media simultaneously, in an integrated manner. The presentation can include sound, graphics, video, text, animation, or any other form of information representation. More particularly, such a presentation can be an auditory smiley and/or a video smiley based on the inclusion of any one or more of the various conventional representations known generally as smileys.

FIG. 2 provides a more detailed schematic illustration of the apparatus 22. The apparatus 22 illustratively includes a menu generation module 26 for generating a menu of available multimedia files. As used herein, the term menu encompasses any presentation such as an on-screen graphic that lists options that can be selected by a user for causing a desired action to be performed, such as choosing a command (like Save As) or applying a particular format to part of a document.

In the present context, the menu lists one or more multimedia files (not shown) that can be stored in a memory contained in the duplex voice-data communication device 24a, 24b to which the apparatus is connected, or stored alternately in an external memory connected to the duplex voice-data communication device. The menu can be conveyed to a system user through a graphical interface on a monitor or other display screen, for example. Such a monitor or other display device can be part of the duplex voice-data communication device 24a, 24b. Other known techniques can be used for conveying the menu to a user, such as presenting an abbreviated command or key list from which a menu item can be selected. Similarly, items contained in or listed by the menu can be selected by a user by highlighting a portion of the monitor, by use of keystroke, or by other known electronic techniques for selecting from a menu.

Using the menu generation module 26, an apparatus user is able to select one or more multimedia files for interposition into the communication or dialog taking place among a plurality of network communicators. The multimedia file can be, for example, an audio smiley. Alternately, a multimedia file can instead be a video smiley, for example.

The apparatus 22 further includes a multimedia file module 28. The multimedia file module 28 outputs at least one of the available multimedia file listed or contained in the menu. During the electronic communication between two or more network communicators, one or more multimedia files is selected using the menu generation module 26. Subsequently, the multimedia file module 28, in response to the selection, outputs the multimedia file. The multimedia file module 28 electronically mixes the selected outputted multimedia file with the voice communication carried by the duplex voice-data communication devices 24a, 24b. This can be performed by the apparatus 22 in real-time. Accordingly, an apparatus user is able to produce an auditory and/or vide smiley during a telephony-based dialog or electronic voice communication over the communication network 20.

As already noted, a plurality of multimedia files may be stored for selection by the apparatus 22 in a memory contained in, or connected to, the duplex voice-data communication device 24a, 24b. Accordingly, the apparatus 22 optionally includes a multimedia updating module 30 for adding additional multimedia files to the plurality of available multimedia files and/or excising existing multimedia files from the plurality of available multimedia files. The new multimedia files also can be, for example, video or audio smileys.

The apparatus 22 also optionally includes a menu modifying module 32. The menu modifying module 32 modifies the menu listing based upon the additions and deletions of additional and existing multimedia files, respectively.

FIG. 2 provides a flowchart that illustrates one embodiment of a method aspect of the invention. The method 200 is capable of being implemented with the above-described apparatus. The method 200 alternately can be implemented in a general purpose computer having voice transmitting and receiving capabilities, or in an application-specific processing device having voice transmitting and receiving capabilities. The method 200, moreover, can be implemented as software, or, alternately, in dedicated circuits having logic gates, memory, or other processing components connected to or contained in a duplex voice-data or other communication device. The method 200 also can be implemented as a combination of software and dedicated circuitry.

The method 200 illustratively includes in step 210 determining whether two or more parties are engaged in a telephony-based conversation. In step 220 one of the parties elects to produce a smiley. The smiley can be an auditory or video file. A menu that lists at least one available multimedia file is provided to the system user in step 230. The user selects a multimedia file by choosing the appropriate file from the menu in step 240.

The method 200 further includes the step 250 of interposing the selected multimedia file in a conversation or dialogue between or among two or more communicators whose conversations are carried over the duplex voice-data or other communication device. The selected file can be interposed into a communication among two or more communicators, where the voice communication is carried by the duplex voice-data or other communication device. When the electronic communication is a voice communication over an interactive telephony-based services system, the step 250 of interposing more specifically includes mixing the voice communication and the at least one outputted multimedia file. The multimedia files can include, for example, video and/or audio smileys

The method 200 optionally includes determining in step 260 whether a party is still engaged in a conversation or dialogue. If so, the process can be repeated for interposing additional multimedia files in response to further user selections.

Optionally the method 200 can also include the steps of adding additional multimedia files to the plurality of available multimedia files and excising existing multimedia files from the plurality of available multimedia files. The method 200, moreover, can include modifying the menu listing based upon the additions and deletions of additional and existing multimedia files, respectively.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

We claim:

1. An apparatus for interfacing with a communication network and interactively interposing a multimedia file output during an electronic communication between a plurality of communication network communicators, the apparatus comprising:
a menu generation module generating a menu listing at least one available multimedia file selected for interposition into the communication by one of the plurality of network communicators; and
a multimedia file module outputting at least one available multimedia file during the electronic communication in response to a menu selection by one of the plurality of communicators.

2. The apparatus of claim 1, wherein the electronic communication comprises interactive voice communication; and wherein the multimedia file module mixes the voice communication and the at least one outputted multimedia file.

3. The apparatus of claim 1, wherein the plurality of multimedia files comprises auditory smileys.

4. The apparatus of claim 1, wherein the plurality of multimedia files comprises video smileys.

5. The apparatus of claim 1, wherein the at least one available multimedia file comprises a plurality of available multimedia files accessible by the multimedia file module; and wherein the apparatus further comprises a multimedia updating module adding additional multimedia files to the plurality of available multimedia files and excising existing multimedia files from the plurality of available multimedia files.

6. The apparatus of claim 5, further comprising a menu modifying module for modifying the menu listing based upon additions and deletions of additional and existing multimedia files.

7. A computer-implemented method of interactively interposing a multimedia file output during an electronic communication between a plurality of communicators, the method comprising the steps of:
providing a menu listing at least one available multimedia file selected for interposition into the communication by one of the plurality of communicators; and
interposing at least one available multimedia file during the electronic communication in response to a menu selection by one of the plurality of communicators.

8. The method of claim 7, wherein the electronic communication comprises interactive voice communication, and wherein the step of interposing comprises mixing the voice communication and at least one outputted multimedia file.

9. The method of claim 7, wherein the plurality of multimedia files comprise auditory smileys.

10. The method of claim 7, wherein the plurality of multimedia files comprise video smileys.

11. The method of claim 7, further comprising the steps of adding additional multimedia files to the plurality of available multimedia files and excising existing multimedia files from the plurality of available multimedia files.

12. The method of claim 11, further comprising the step of modifying the menu listing based upon additions and deletions of additional and existing multimedia files.

13. A computer readable storage medium for use in a communication network during an electronic communication between a plurality of communication network communicators, the storage medium comprising computer instructions for:
providing a menu listing at least one available multimedia file selected for interposition into the communication by one of the plurality of communicators; and
outputting at least one available multimedia file during the electronic communication in response to a menu selection by one of the plurality of communicators.

14. The computer readable storage medium of claim 13, wherein the electronic communication comprises voice communication, and wherein the computer instruction for outputting at least one available multimedia file comprises mixing the voice communication and at least one outputted multimedia file.

15. The computer readable storage medium of claim 13, wherein the plurality of multimedia files comprise auditory smileys.

16. The computer readable storage medium of claim 13, wherein the plurality of multimedia files comprise video smileys.

17. The computer readable storage medium of claim 13, further comprising computer instructions for adding additional multimedia files to the plurality of available multimedia files, excising existing multimedia files from the plurality of available multimedia files, and modifying the menu listing based upon additions and deletions of additional and existing multimedia files.
